(19) United States
(12) Patent Application Publication
(10) Pub. No.: US 2014/0124097 A1
(43) Pub. Date: May 8, 2014

(54) LOG SPLITTING APPARATUS HAVING LOG SPLITTER FRAME WITH STRIPPER PLATES

(71) Applicant: Frictionless World LLC, Louisville, CO (US)

(72) Inventor: Daniel Banjo, Boulder, CO (US)

(73) Assignee: Frictionless World LLC, Louisville, CO (US)

(21) Appl. No.: 13/887,975

(22) Filed: May 6, 2013

Related U.S. Application Data
(63) Continuation-in-part of application No. 29/436,770, filed on Nov. 8, 2012, now Pat. No. D681701.

(51) Int. Cl. B27L 7/06

(52) U.S. Cl. CPC B27L 7/06
USPC 144/193.1

(57) ABSTRACT

A log splitting apparatus having stripper plates for stripping logs from a blade member as a piston is retracted into a cylinder. In one arrangement, the stripper plates are removably securable to opposing sides of a log splitter frame of the apparatus to allow for replacement of the stripper plates with other stripper plates or other components (e.g., stroke reducing devices), use of multi-way (e.g., 4-way) wedge systems, and/or the like.

### RELATED APPLICATIONS

This application is a continuation-in-part of U.S. Design application Ser. No. 29/436,770, filed Nov. 8, 2012, and entitled “LOG SPLITTER BEAM,” the entirety of which is hereby incorporated by reference.

### FIELD

The present invention relates to a wood or log splitting apparatus and, more particularly, to a log splitter frame including stripper plates for dislodging logs during a return stroke of a splitting blade.

### BACKGROUND

Continued popularity of wood as a source of heat has lead to increasing use of powered apparatus for wood splitting purposes. Many different forms of mechanical wood splitters have been developed. The most common design involves a frame mounted blade and platform arrangement wherein the blade, platform or both are driven toward and away from one another usually by a hydraulic cylinder. A wood block is placed between the blade and platform and the cylinder is activated to move the platform and blade together relative to one another thereby driving the blade through the wood block.

### SUMMARY

Disclosed herein is an apparatus for splitting logs including an elongated beam, a mounting lug adjacent a first opposing end of the beam, a foot plate adjacent a second opposing end of the beam, and first and second stripper plates respectively removably mountable adjacent the first and second sides of the beam. In one arrangement, first and second mounting bracket assemblies may be secured or securable to the first and second sides of the beam, where the first and second stripper plates may be removably securable to the first and second mounting bracket assemblies to removably mount the first and second stripper plates adjacent the first and second sides of the beam. For instance, first and second bolt and nut assemblies may be used to removably secure the first and second stripper plates to the first and second mounting bracket assemblies, such as by inserting the bolts through aligned apertures through the stripper plates and mounting bracket assemblies and then threading the nuts onto the ends of the bolts.

Any of the embodiments, arrangements, and the like discussed herein may be used (either alone or in combination with other embodiments, arrangement, and the like) with any of the disclosed aspects. Any feature disclosed herein that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the. Moreover, any failure to use phrases such as “at least one” also does not limit the corresponding feature to the singular. Use of the phrase “generally,” “at least generally,” “substantially,” “at least substantially” or the like in relation to a particular feature encompasses the corresponding characteristic and insubstantial variations thereof. Finally, a reference of a feature in conjunction with the phrase “in one embodiment” or the like does not limit the use of the feature to a single embodiment.

Reference will now be made to the following drawings, which assist in illustrating the various pertinent features of the various novel aspects of the present disclosure.

### BRIEF DESCRIPTION OF THE DRAWINGS

FIG. 1a is a perspective view of a log splitting apparatus according to one embodiment including a log splitter frame in a horizontal position.

FIG. 1b is a perspective view similar to FIG. 1 but with the log splitter frame in a vertical position.

FIG. 2 is a perspective view of the log splitter frame of FIG. 1.

FIG. 3 is a top view of the log splitter frame of FIG. 2.

FIG. 4 is a bottom view of the log splitter frame of FIG. 2.

FIG. 5 is a right side view of the log splitter frame of FIG. 2.

FIG. 6 is a front view of the log splitter frame of FIG. 2.

FIG. 7 is a rear view of the log splitter frame of FIG. 2.

### DETAILED DESCRIPTION

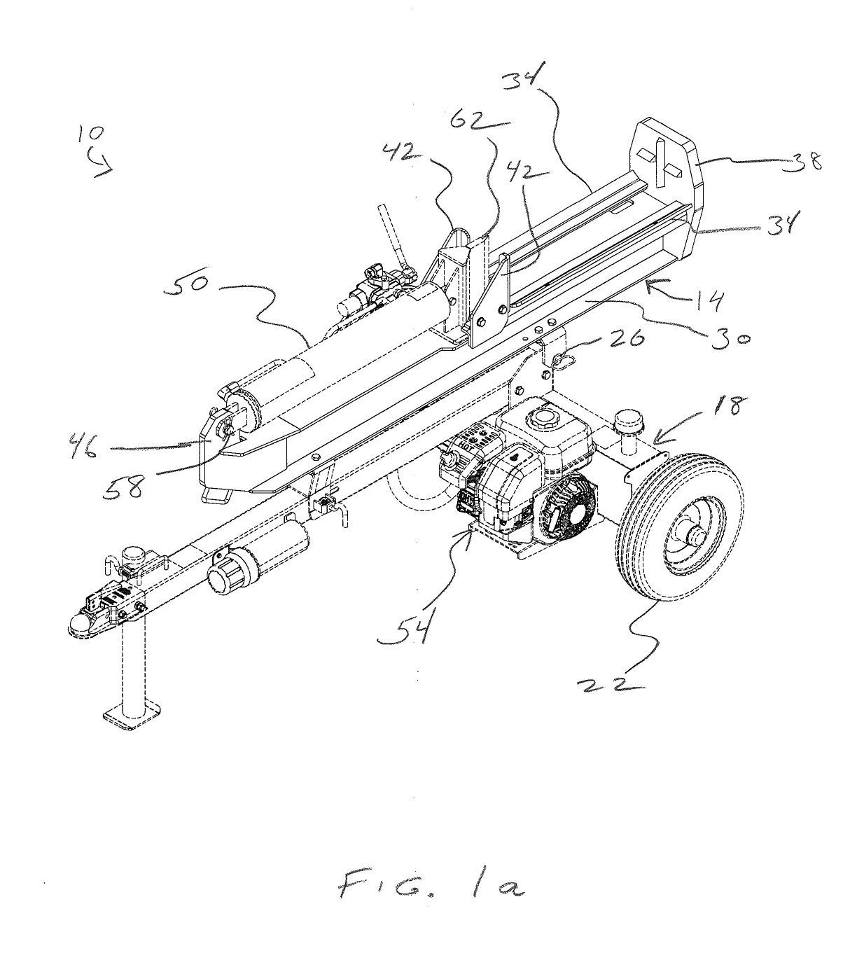

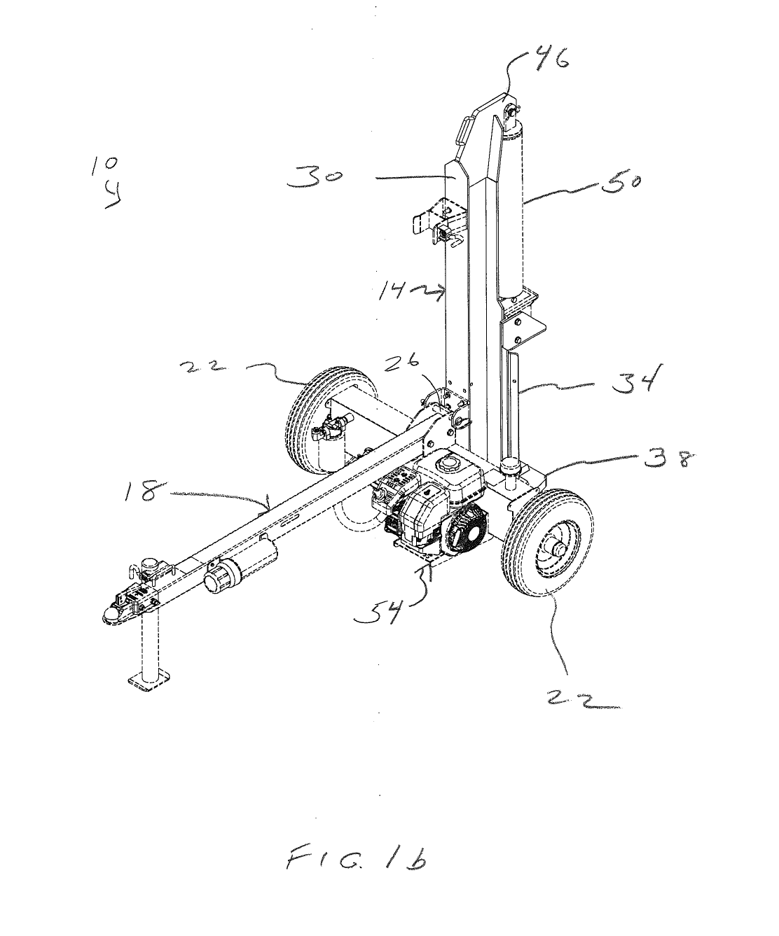

FIG. 1a is a perspective view of a log splitting apparatus 10 broadly including a log splitter frame 14 for splitting logs (not shown) placed thereon, where the log splitting frame 14 is mountable onto a carriage 18 having a pair of wheels 22 for supporting and facilitating transport of the frame 14. For instance, the log splitter frame 14 may be pivotally connected to the carriage 18 via pivot pin 26 for pivotal movement of the log splitter frame 14 between at least first and second positions, such as horizontal and vertical positions as shown in FIGS. 1a and 1b.

The log splitter frame 14 may broadly include a support beam 30 such as an I-beam or the like (e.g., including first and second opposing ends, first and second opposing sides, and top and bottom opposing surfaces, not labeled), cradle members 34 (e.g., a pair of cradle members 34) appropriately secured or securable to the beam 30 and collectively forming a cradle for supporting at least one log (not shown) placed thereon or therebetween, a foot plate 38 secured or securable generally adjacent a first end of the cradle members 34 for providing an opposing force against a log placed on the cradle members 34 and being pushed against the foot plate 38 by a blade member (discussed blow), and stripper plates 42 (e.g., a pair of stripper plates 42) secured (e.g., via welding) or removably securable (e.g., via bolt and nut assemblies) generally adjacent an opposing second end of the stripper plates 42 and/or beam 30 for stripping split logs from the blade member as the same is retracted (e.g., due to twisted grain and/or other inconsistencies in the logs). The stripper plates 42 will be discussed in more detail later on in this disclosure.

The log splitter frame 14 may also include an anchoring member such as an attachment lug 46 (e.g., part of the beam 30) to which a hydraulic cylinder 50 may be removably secured (e.g., via pin 58). A drive assembly 54 (e.g., including an engine assembly, a hydraulic reservoir, etc.) may be fluidly interconnected to the hydraulic cylinder 50 via hydraulic lines (not labeled) for purposes of advancing and retracting a piston (not shown) within the hydraulic cylinder 50 to split logs placed on the cradle members 34. A blade member 62 (e.g., including a single wedge for splitting a log in two, two wedges substantially perpendicular to each other for splitting a log in four, etc.) may be appropriately secured or securable to the piston and designed to split a log placed on the cradle members 34. More specifically, advancement of the piston from a first position substantially within the hydraulic cylinder 50 (as in FIGS. 1a-1b) to a second position that is closer to the foot plate 38 causes the blade member 62 to urge the log against the foot plate 38 and then eventually split the log as the blade member 62 continues to advance towards the foot plate 38.

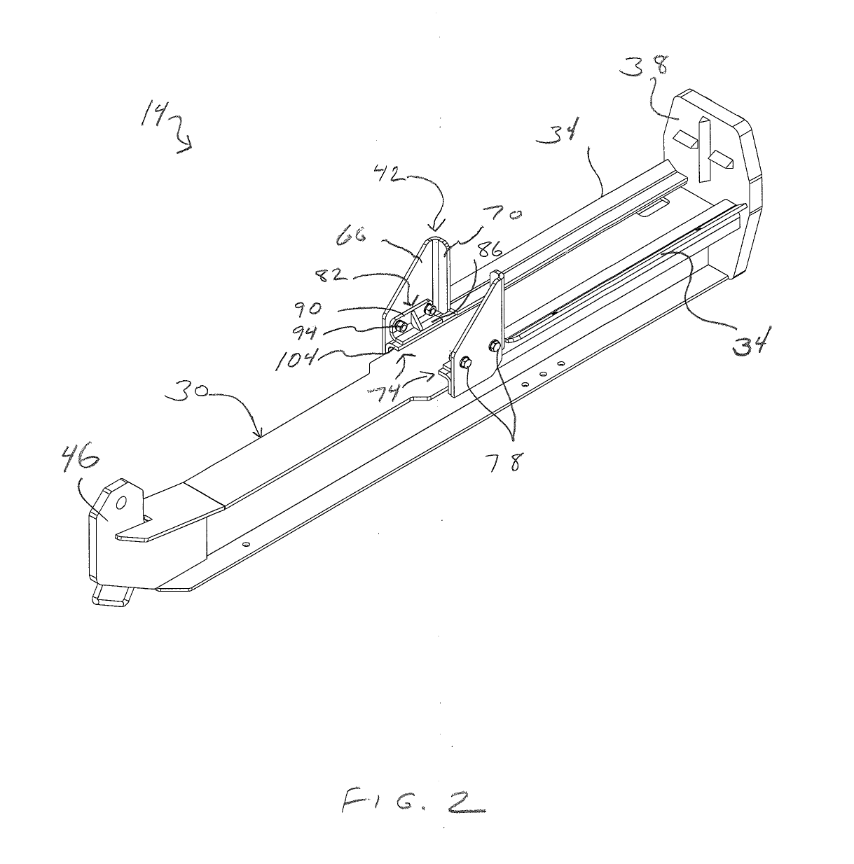

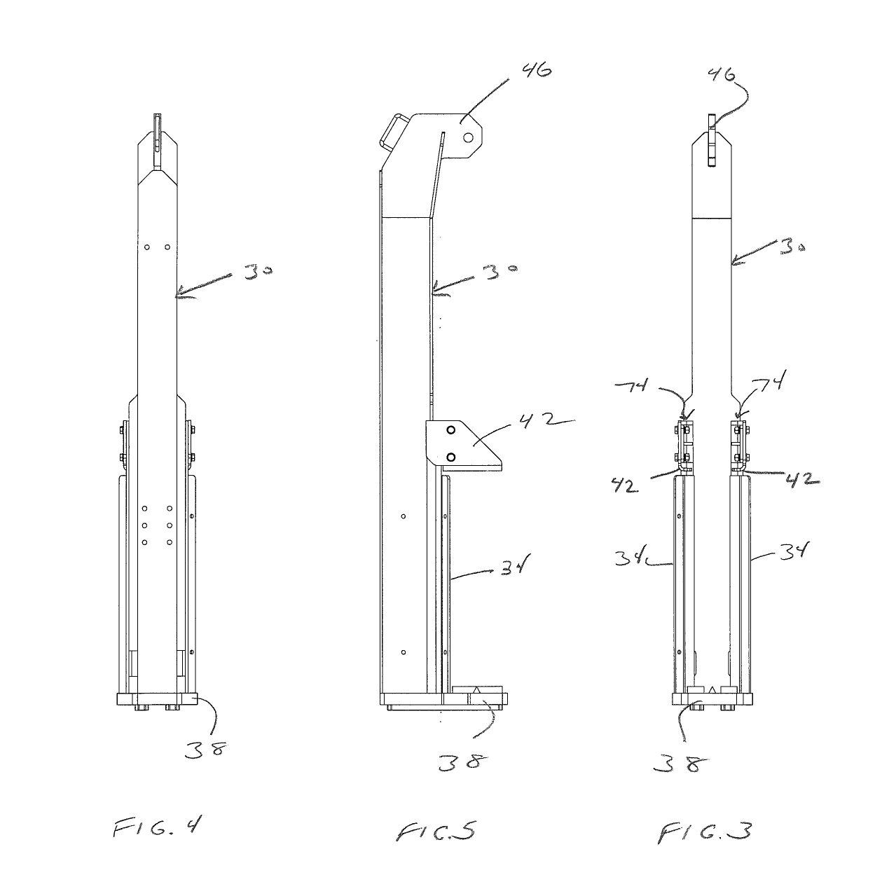

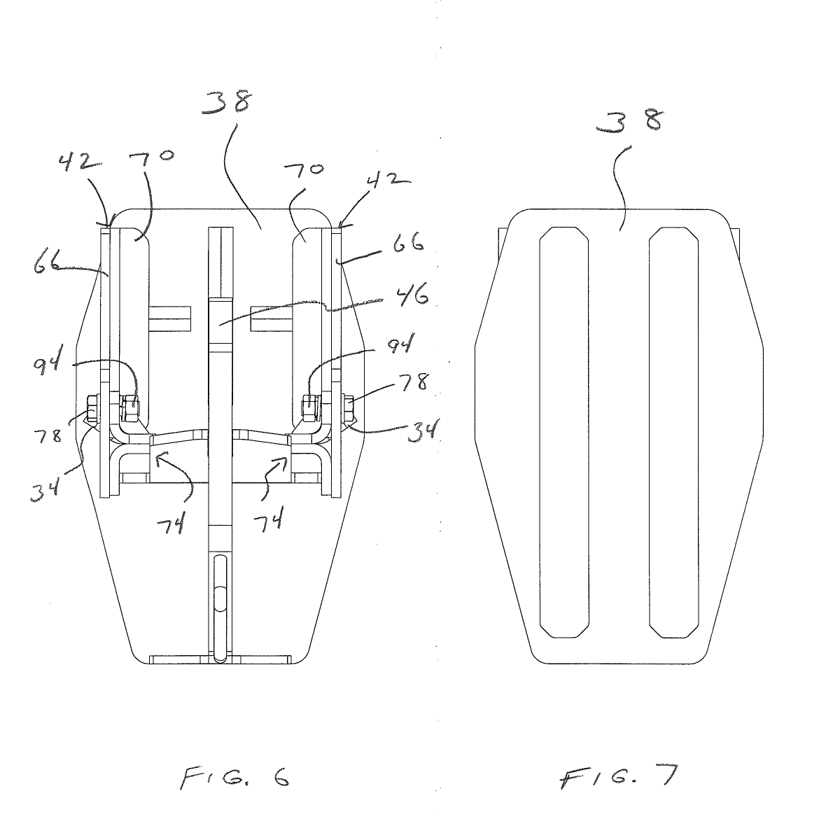

With specific reference now to FIG. 2, the stripper plates 42 may be secured or securable to opposing sides of the frame 14 so that the piston and blade member 62 can be passed therebetween, such as to opposing sides of the beam 30 (as shown in FIG. 2), to the opposing stripper plates 34, and/or the like. Each stripper plate 42 may generally include a body portion 66 and a contact portion 70, where the body portion 66 generally provides stability to the contact portion as a log is being urged against the contact portion 70 during a return stroke of the piston (i.e., in a direction towards the lug 46) so as to strip the log from the blade member 62. While the contact portions 70 of the stripper plates 62 have been shown as being bent inwardly towards each other so as to provide a substantially flat surface against which logs may be urged during the return stroke of the piston, it is to be understood that other shapes and forms of the contact portions 70 are also envisioned and encompassed within the scope of the present disclosure.

In one arrangement, each stripper plate 62 may be removably secured or attached to opposing sides of the frame 14. As an example, a respective mounting bracket assembly or arrangement 74 may be secured to (e.g., via welding) or securable to opposing sides of the beam 30, where each mounting bracket arrangement 74 may include one or more apertures therethrough (not shown) that are configured to align with respective apertures (not shown) through the body portions 66 of the stripper plates 42 for receipt of respective bolts 78 to secure the stripper plates 42 to the beam 30. For instance, each mounting bracket arrangement 74 may include at least a first bracket 82 including a mounting portion 86 that may be secured to the beam 30 (e.g., via welding the mounting portion 86 to the top of the beam 30 or to a flange 104 of the beam 30) or removably securable to the beam 14 (e.g., via aligned apertures and bolts, not shown), and an attachment portion 90 through which the apertures are disposed and to which the stripper plate 42 may be removably secured to (via a bolt 78 and respective nut 94).

The attachment portion 90 may include a outer surface (not labeled) against which the body portion 66 of a stripper plate 42 may be stably urged and mounted against as a nut 94 is threaded onto a respective bolt 78 (collectively, a nut and bolt assembly) and tightened against an opposing inner surface of the attachment portion 90. In another arrangement, each stripper plate 42 may be substantially directly removably secured to the beam 14 or cradle member 34 (e.g., via inserting a bolt 78 through aligned apertures in the stripper plate 42 and beam 14 and/or cradle member 34 and threading a nut 94 onto the bolt 78). While a few manners of removably securing the stripper plates 42 to the beam 30 or cradle members 34 has been disclosed, other manners of doing so are envisioned and encompassed herein.

Removability of the stripper plates 42 (e.g., via loosening the nuts 94 and removing the bolts 78 from the aligned apertures of the stripper plates 42 and mounting bracket arrangements 74 and/or in other manners) provides numerous advantages. In one regard, removability of the stripper plates 42 allows for efficient replacement of damaged stripper plates 42, replacement of the stripper plates 42 with different sized/configured stripper plates 42, and/or the like. In another regard, removability of the stripper plates 42 allows for replacement of the stripper plates 42 with other components (e.g., via inserting the bolts 78 through aligned apertures through the mounting bracket arrangements 74 and such other components). In one arrangement, the stripper plates 42 could be removed and replaced with any appropriate stroke reducing/limiting devices designed to dislodge shorter logs. For instance, the stroke reducing devices may essentially be in the form of stripper plates whose contact portions are disposed closer to the foot plate 38 than are the contact portions 70 of stripper plates 42 shown in FIG. 2. In one variation, the stroke reducing devices may be appropriately removably secured to the stripper plates 42 without removing the stripper plates 42 from the frame 14.

In a further regard, removability of the stripper plates 42 may allow for installation and use of any appropriate multi-way (e.g., 4-way) wedge system. For instance, in the case where the blade member 62 includes both vertical and horizontal wedges (“vertical” and “horizontal” being in relation to the orientation of the log splitter frame 14 in FIG. 1a), the horizontal wedge may not be able to fit through the space between the contact portions 70 of the stripper plates 42. In this regard, the stripper plates 42 may be appropriately removed from the frame 14 before the piston and blade member 62 are advanced. In one variation, the stripper plates 42 may be removed and replaced with stripper plates 42 sized/configured to allow for passage of a multi-wedge blade member 62 therebetween.

The foregoing description has been presented for purposes of illustration and description. Furthermore, the description is not intended to limit the invention to the form disclosed herein. Consequently, variations and modifications commensurate with the above teachings, and skill and knowledge of the relevant art, are within the scope of the disclosure herein. The embodiments described hereinabove are further intended to explain best modes known of practicing the invention and to enable others skilled in the art to utilize the invention in such, or other embodiments and with various modifications required by the particular application(s) or use(s) of the invention. It is intended that the appended claims be construed to include alternative embodiments to the extent permitted by the prior art.

What is claimed is:

1. An apparatus for splitting logs, comprising:
an elongated beam comprising first and second opposing ends, first and second opposing sides, and top and bottom opposing surfaces;
a mounting lug adjacent the first opposing end of the beam;
a foot plate adjacent the second opposing end of the beam; and
first and second stripper plates respectively removably mountable adjacent the first and second sides of the beam.

2. The apparatus of claim 1, further comprising:
first and second mounting bracket assemblies secured or securable to the first and second sides of the beam, wherein the first and second stripper plates are removably securable to the first and second mounting bracket assemblies to removably mount the first and second stripper plates adjacent the first and second sides of the beam.

3. The apparatus of claim 2, further comprising:
first and second bolt and nut assemblies for removably securing the first and second stripper plates to the first and second mounting bracket assemblies.

4. An apparatus for splitting logs, comprising:
an elongated beam comprising first and second opposing ends, first and second opposing sides, and top and bottom opposing surfaces;
a mounting lug adjacent the first opposing end of the beam;
a foot plate adjacent the second opposing end of the beam;
first and second mounting bracket assemblies secured adjacent the first and second sides of the beam;
first and second stripper plates respectively secured to the first and second mounting bracket assemblies; and
first and second bolts respectively inserted through the first and second stripper plates and first and second mounting bracket assemblies.
